(19) United States
(12) Patent Application Publication
(10) Pub. No.: US 2026/0222180 A1
(43) Pub. Date: Jul. 30, 2026

(54) ANTI-COLLUSION CLIENT-SERVER METHOD AND SYSTEM FOR HOMOMORPHICALLY ENCRYPTED DATA

(71) Applicant: COMMISSARIAT A L'ENERGIE ATOMIQUE ET AUX ENERGIES ALTERNATIVES, Paris (FR)

(72) Inventors: Renaud SIRDEY, Gif-Sur-Yvette (FR); Aymen BOUDGUIGA, Gif-Sur-Yvette (FR); Martin ZUBER, Gif-Sur-Yvette (FR)

(73) Assignee: COMMISSARIAT A L'ENERGIE ATOMIQUE ET AUX ENERGIES ALTERNATIVES, Paris (FR)

(21) Appl. No.: 19/143,280

(22) PCT Filed: Dec. 26, 2023
(86) PCT No.: PCT/FR2023/052123

§ 371 Date: Jun. 25, 2025

(30) Foreign Application Priority Data
Dec. 29, 2022 (FR) FR2214638

(51) Int. Cl. H04L 9/08; G06F 21/62

(52) U.S. Cl. CPC H04L 9/0825; G06F 21/6227; H04L 2209/127

(57) ABSTRACT

The present invention relates to a client-server system implementing a client, a compute server, and a service provider delegating, to the compute server, an operation to be performed in the homomorphic domain on confidential data from the client. The system can be protected from possible collusions of a first type between the compute server and the service provider by virtue of an HSM_{SP} module with which the latter is provided. The HSM_{SP} module contains the homomorphic cryptosystem of the service provider and is suitable for decrypting, on its behalf, the result of an operation performed by the compute server. The system can be protected from possible collusions of a second type between the compute server and the client by virtue of an HSM_{CL} module with which the latter is provided. The HSM_{CL} module contains the homomorphic cryptosystem of the client and is suitable for decrypting, of its behalf, the result of an operation performed by the compute server.

### TECHNICAL FIELD

The present invention relates to the field of homomorphic encryption. It is particularly applicable in the field of confidential computing and in that of confidential creation/querying of a database hosted by a remote server.

### PRIOR ART

The development of cloud computing combined with confidentiality constraints of some data have led to the rise of homomorphic cryptography. In the context of a conventional application, a client wishing to execute an operation on confidential data encrypts these data using the public key of a recipient's homomorphic cryptosystem, and transmits them to a remote compute server (CS). This compute server performs the operation in the homomorphic domain on the encrypted data and transmits the result obtained to the recipient. The recipient then only has to decrypt the result using the private key of its homomorphic cryptosystem to obtain the unencrypted result. A homomorphic cryptosystem is understood here to mean a public-private key pair allowing homomorphic encryption and its decryption.

However, this configuration of delegating the computation from the client to a compute server CS generates risks of collusion between the various entities involved.

A first case of collusion is illustrated in FIG. 1, which diagrammatically shows a client CL, a compute server CS and a recipient of the result, in this case a service provider SP. It is assumed that the compute server CS and service provider SP are honest but curious.

The client CL wishing to perform an operation ƒ on confidential data data_{c} encrypts them in step 110 using the public key FHE.pk of the homomorphic cryptosystem (FHE.pk, FHE.sk) of the recipient SP, and transmits them to the compute server CS. The compute server performs the operation in step 120 in the homomorphic domain on the encrypted data, i.e. on FHE.pk(data_{c}). The result ƒ(FHE.pk(data_{c}))=FHE.pk(res_{c}) is transmitted in step 130 to the recipient SP who decrypts the data in step 140 using its private key to obtain the unencrypted result res_{c}.

A first type of collusion is likely to occur between the compute server CS and the recipient SP: the compute server can indeed transmit the encrypted data directly FHE.pk(data) to the recipient, in which case the latter can access the unencrypted data data_{c} by decrypting it using the private key FHE.sk. However, these data are confidential and must under no circumstances be transmitted to the recipient of the result (service provider).

A second type of collusion is illustrated in FIG. 2, the entities involved in the configuration represented being identical to those of FIG. 1. Here it is assumed that the client CL and compute server CS are honest but curious.

In this configuration, the recipient of the result is no other than the client CL, whereby the service provider SP provides the compute server CS with the operation ƒ (for example an inference operation or a search operation in a confidential database of the SP) to be performed in the homomorphic domain. The operation ƒ is confidential with respect to the compute server CS and the homomorphic cryptosystem (FHE.pk′, FHE.sk′) is that of the client CL.

The service provider SP transmits, in step 210, to the compute server CS, the expression of the operation ƒ in question in the homomorphic domain, i.e. FHE.pk ‘(ƒ). When the client CL transmits, to the compute server in step 220, encrypted confidential data data, using the public key FHE.pk’, the compute server performs, in step 230, the operation in the homomorphic domain on the encrypted data, namely FHE.pk′(data_{c}). The result FHE.pk′(res_{c}) is returned to the client CL in step 240, which decrypts them in step 250 using its private key to obtain the unencrypted result res_{c}.

A collusion can occur between the client CL and the compute server CS if the latter transmits the encrypted operation FHE.pk′(ƒ) to the former, thus enabling the client CL to discover the operation ƒ delegated to the server CS by the service provider SP. Thus, in the case of a search operation in a confidential database, for example a biometric database encrypted by FHE.pk′(ƒ), the client may have access to the unencrypted content of the database in question.

Various measures have been considered in the prior art to protect against the risks of collusion between entities of a client-server system operating on homomorphically encrypted data.

Thus, the article by J. Li et al. entitled “A lattice-based homomorphic proxy re-encryption scheme with strong anti-collusion for cloud computing” published in Sensors, 2021, vol. 21, No. 1, 288, pp. 1-20 proposes a re-encryption technique using a proxy server, each entity having a public encryption key, a public evaluation key and a secret decryption key. However, this solution has the drawback of being complex to implement.

The article by D. Natarajan et al. entitled “CHEX-MIX: Combining homomorphic encryption with trusted execution environments for two-party oblivious inference in the Cloud” published in Cryptology ePrint Archive (2021), pp. 1-21 describes a two-party inference method in the Cloud, the service provider SP transmitting, to an enclave SGX of the compute server CS the parameters of the inference model in the homomorphic domain and the client CL transmitting, for its part to the compute server CS, the homomorphically encrypted confidential data for processing inside the enclave. The client CL decrypts the result using its private key. The presence of the enclave within the compute server CS makes it possible to avoid collusions of the second type described above. However, this solution is not immune to side-channel attacks or the insertion of backdoors into the enclave code.

The purpose of the present invention is therefore to propose a client-server system that avoids the risks of collusion between the different entities of this system, while remedying the drawbacks of the prior art, in other words which is simple and robust to the aforementioned attacks.

### DESCRIPTION OF THE INVENTION

The present invention is defined by a client-server system comprising a client, a compute server and a service provider, said service provider delegating, to the compute server, an operation to be performed on confidential data from the client, the compute server being suitable for performing said operation on the confidential data, encrypted using the public key of a homomorphic cryptosystem, said client-server system being original in that the service provider, respectively the client, is provided with a hardware security module (HSM_{SP}, HSM_{CL}) containing said homomorphic cryptosystem and suitable for decrypting the result of the operation using the private key of said homomorphic cryptosystem to transmit it to the service provider, respectively to the client.

Advantageously, the client is suitable for encrypting said confidential data using the public key of the homomorphic cryptosystem and for transmitting them thus encrypted to the compute server.

According to a first embodiment, said client is provided with the hardware security module and the service provider transmits, to the compute server, the parameters of the operation to be performed, which parameters are encrypted using the public key of the homomorphic cryptosystem.

According to a second embodiment, the service provider is provided with the hardware security module and the compute server hosts a database encrypted using the public key of the homomorphic cryptosystem, the operation being a primitive indicating whether the confidential data are present in or absent from the database, the service provider returning to the compute server an access code to store the data in the database if the indicator indicates that the data are absent from the database.

In this case, to query confidential data in the database, a third-party client transmits to the compute server a query encrypted using the public key of the homomorphic cryptosystem, said query being evaluated in the homomorphic domain, the result of the query then being transmitted to the hardware security module for decryption therein using the secret key of the homomorphic cryptosystem.

According to an alternative of the second embodiment, the service provider is provided with the hardware security module and the compute server hosts a database encrypted using the public key of a second homomorphic cryptosystem that is separate from the homomorphic cryptosystem stored in the hardware security module.

In this case, the client transmits, to the compute server, the confidential data encrypted using the public key of the second homomorphic system and the compute server performs the operation in the homomorphic domain of the second homomorphic system, with the compute server then performing a key switch for the result of the operation to obtain a result encrypted in the first homomorphic system.

To query confidential data in the database, a third-party client may transmit, to the compute server, a query encrypted using the public key of the second homomorphic cryptosystem, said query then being evaluated by the server in the homomorphic domain of the second homomorphic system, then being the subject of a key switch to the first homomorphic system, the encrypted result of the query then being transmitted to the hardware security module for decryption 25 therein using the secret key of the first homomorphic cryptosystem.

The homomorphic cryptosystem is preferably an FHE cryptosystem.

### BRIEF DESCRIPTION OF THE DRAWINGS

Other features and advantages of the invention will appear upon reading a preferred embodiment of the invention, given with reference to the accompanying figures, wherein:

FIG. 1, already described, represents a first type of collusion between the server of a service provider and a compute server in a client-server architecture;

FIG. 2, already described, represents a second type of collusion between a client and a compute server in a client-server architecture;

FIG. 3 diagrammatically represents a client-server anti-collusion system of the first type, according to a first embodiment of the invention;

FIG. 4A and

FIG. 4B diagrammatically represent the creation and querying of a private database using a client-server system according to the first embodiment of the invention;

FIG. 5A

FIG. 5B diagrammatically represent the creation and querying of a private database using a client-server system according to an alternative of the first embodiment of the invention;

FIG. 6 diagrammatically represents a client-server anti-collusion system of the second type, according to a second embodiment of the invention;

FIG. 7 diagrammatically represents a client-server anti-collusion system of the second type, according to an alternative of the second embodiment of the invention.

### DETAILED DISCLOSURE OF PARTICULAR EMBODIMENTS

The description below refers to a server client system whose basic configuration is identical to that described above, i.e. comprising a client CL, and a service provider SP delegating an operation ƒ (in the homomorphic domain) to a compute server CS. In all cases, the client transmits, to the compute server, confidential data, data_{c}, encrypted using the public key of a homomorphic cryptosystem, whether that of the service provider (FHE.pk, FHE.sk) or its own cryptosystem (FHE.pk′, FHE.sk′).

The idea behind the present invention is to add a TTP-certified (Trusted Third Party) hardware security module (or HSM) to the service provider (to avoid collusions of the first type) or to the client (to avoid collusions of the second type), this HSM module being the only element of the system that can have access to the private key of the homomorphic cryptosystem used to encrypt the client's data (prevention of collusions of the first type) or to encrypt the parameters of the operation delegated by the service provider (prevention of collusions of the second type). Thus, in all cases, the entity receiving the encrypted information (confidential data to which the operation applies, or parameters of the confidential operation) cannot directly access the private key of the homomorphic system and use it for purposes other than that of decrypting said information. In particular, a collusion of the first type is avoided in that the service provider SP cannot use the private key FHE.sk to decrypt the encrypted confidential data FHE.pk(data_{c}) that the compute server could transmit thereto. Even if the service provider is malicious, it will not be any more able to transmit the private key FHE.sk to the compute server for decryption of the confidential data. Similarly, a collusion of the second type is avoided in that the client cannot use the private key FHE.sk′ to decrypt the parameters of the operation (e.g. the parameters of the inference model or of the search operation) that could be transmitted thereto by the compute server. Even if the client is malicious, it will not be any more able to transmit its private key FHE.sk′ to the compute server for it to decrypt the parameters in question.

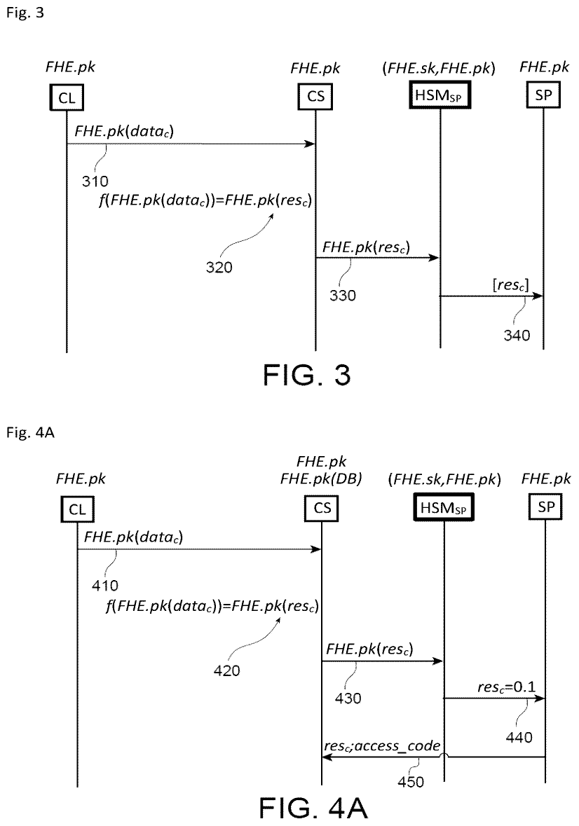

FIG. 3 diagrammatically represents a client-server anti-collusion system of the first type, according to a first embodiment of the invention.

In this embodiment, the recipient of the result of the operation ƒ on the client's confidential data, data_{c}, i.e. the service provider SP, has an HSM module, given the reference HSM_{SP}. It should be recalled that an HSM is a module used to generate, store and protect cryptographic keys as well as to execute cryptographic primitives using these keys. This module can be in the form of an electronic board plugged into a computer or in the form of an external unit. This module is chosen to be TTP-certified, i.e. it is authorized to perform cryptographic operations as a trusted third party.

The HSM_{SP} module generates the public and private key pair of the homomorphic cryptosystem (FHE.pk, FHE.sk), the public key is shared with the client CL and the compute server CS.

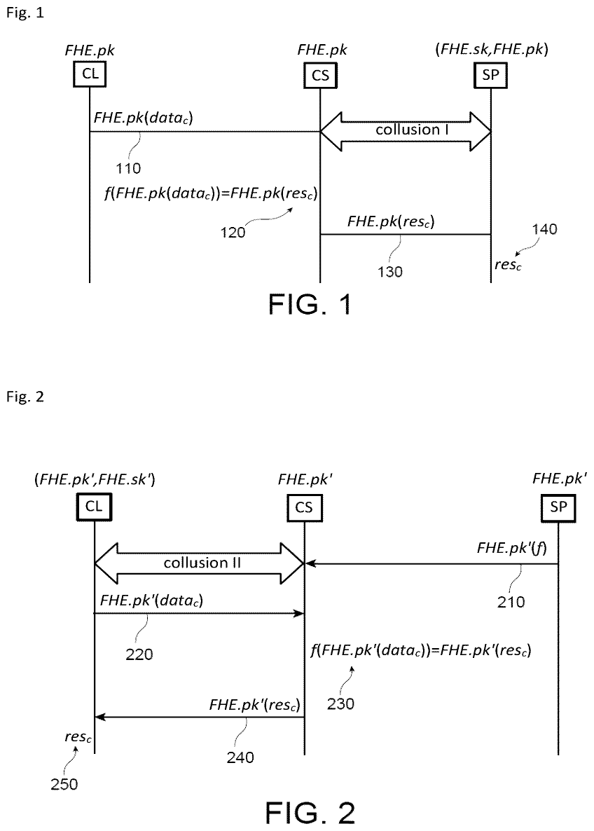

As shown in FIG. 1, the client CL wishing to perform an operation ƒ on confidential data data, encrypts them in step 310 using the public key FHE.pk of the homomorphic cryptosystem and transmits them to the compute server CS. The compute server performs the operation in step 320 in the homomorphic domain on the encrypted data, and the result ƒ(FHE.pk(data_{c}))=FHE.pk(res_{c}) is transmitted in step 330 to the HSM which decrypts them using the private key FHE.sk stored therein. In step 340, the result is provided in unencrypted or even in encrypted form (given the reference [res_{c}]) to the service provider SP. This encryption can be conventional asymmetric (non-homomorphic) or symmetric encryption.

The presence of the HSM_{SP} module prevents any collusion between the compute server CS and the service provider SP as the latter no longer has access to the decryption key FHE.sk.

Preferably, the HSM_{SP} module ensures, before providing the result of the decryption to the SP, that the latter corresponds to the expected format of the operation ƒ. To this end, so-called verifiable computing (VC) functions can be used to prove that the operation ƒ has been carried out correctly. This measure prevents the HSM_{SP} module from being used as a decryption oracle, i.e. from decrypting any message sent thereto in order to obtain information about the key FHE.sk.

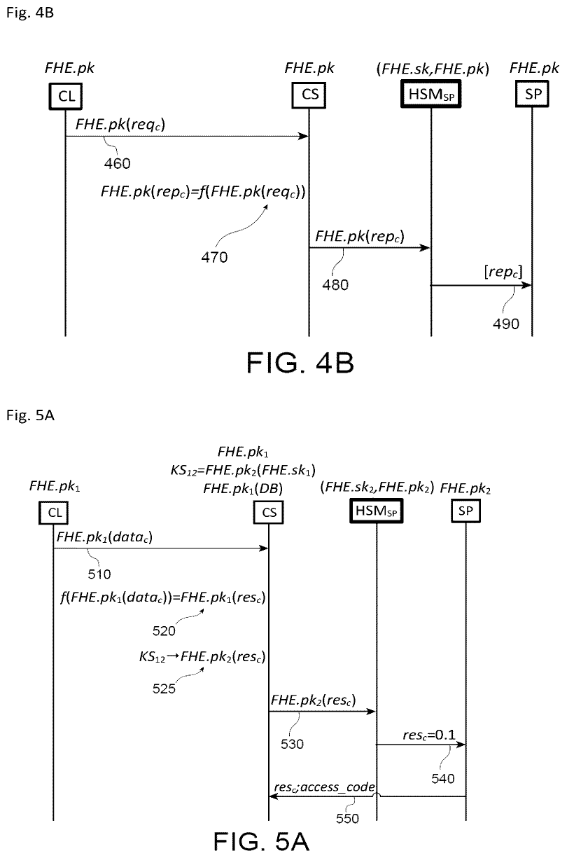

The client-server anti-collusion system according to the first embodiment of the invention can be used in the context of creating and querying a database DB as illustrated in FIGS. 4A and 4B.

The operation ƒ is used to identify if confidential information is already present in the database DB. Thus, for example, the result can be res_{c}=0 if the confidential information is absent and res_{c}=1 if this information is already present in a record of the database.

When a client wants to create a new record in the database, it transmits, in step 410, the encrypted information FHE.pk(data) to the compute server, hosting the database. This is assumed to be stored in encrypted form by the public key of the homomorphic cryptosystem, i.e. FHE.pk(DB). In step 420, the compute server evaluates the function ƒ in the homomorphic domain and determines whether the information is present therein. The function ƒ can be, for example, a Private Information Retrieval (PIR) protocol primitive. The result of the evaluation in the homomorphic domain, i.e. ƒ(FHE.pk(data_{c}))=FHE.pk(res_{c}), is transmitted, in step 430, to the HSM_{SP} module of the service provider SP. The HSM_{SP} module decrypts the result using the private key FHE.sk stored therein and provides the SP, in step 440, with the indicator indicating the presence/absence of the record, i.e. res_{c}. Optionally, the HSM_{SP} module encrypts this indicator using the public key of a conventional asymmetric (non-homomorphic) encryption or the secret key of a symmetric encryption before providing it [res_{c}] to the SP.

The service provider SP can then return, in step 450, to the compute server CS an access code (for example a hash value) in addition to the presence/absence indicator. Depending on the type of application, the access code and the indicator can be transmitted in unencrypted or encrypted form (using conventional encryption) to the compute server. If the indicator indicates that the record is absent, the database DB can be updated by storing the information data, at the address encoded by the access code.

Once the database has been established, a client CL can query it by transmitting, in step 460, to the compute server CS that hosts it, a query encrypted using the public key of the homomorphic system, i.e. FHE.pk(req_{c}). The compute server CS performs the operation ƒ on the query req, to evaluate, in step 470, the response in this domain, i.e. FHE.pk(rep_{c})=ƒ(FHE.pk(req_{c})). In step 480, the response is transmitted to the HSM_{SP} module, which decrypts it using the private key FHE.sk that it contains. The latter can transmit it in unencrypted or encrypted form ([rep_{c}]) using conventional encryption (asymmetric non-homomorphic or symmetrical encryption) to the service provider SP, in step 490.

According to an alternative embodiment, the database DB hosted by the compute server CS can be encrypted using (the public key of) a homomorphic cryptosystem separate from that stored in the HSM_{SP} module. More specifically, the first cryptosystem associated with the compute server is given the reference (FHE.pk₁, FHE.sk₁) and the second cryptosystem associated with the service provider's HSM_{SP} module is given the reference (FHE.pk₂, FHE.sk₂).

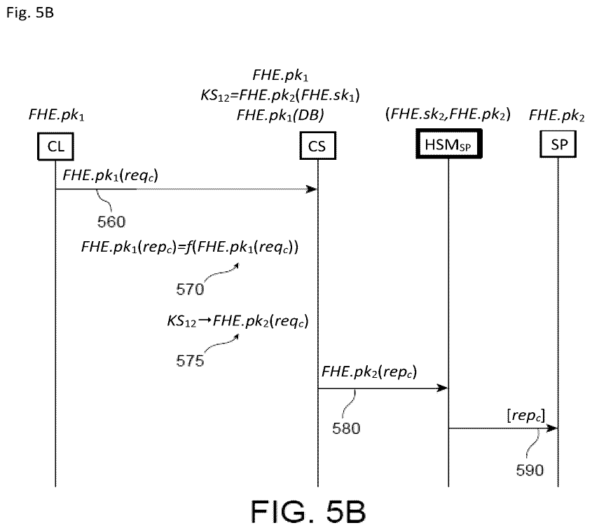

The creation of the database DB according to this alternative embodiment of the client-server anti-collusion system is illustrated in FIG. 5A.

The client CL encrypts the confidential information data, using the public key FHE.pk₁ and transmits it in step 510 to the compute server CS whose database is itself stored in encrypted form, having been encrypted by the key FHE.pk₁. The compute server also has a switch key KS₁₂=FHE.pk₂ (FHE.sk₁).

As previously stated, in step 520, the compute server evaluates the function ƒ on the entry data, in the homomorphic domain to determine whether this information is present in a record of the database. The result of this evaluation ƒ(FHE.pk₁ (data_{c}))=FHE.pk₁ (res_{c}) is then subject, in step 525, to a key switch in the homomorphic domain key KS₁₂=FHE.pk₂ (FHE.sk₁). Various key switching techniques are known from the prior art. A description thereof can be found in particular in the article by A. Kim et al. entitled “Revisiting homomorphic encryption schemes for finite fields” published in the International Conference on the Theory and Application of Cryptology and Information Security. Springer, Cham, 2021. p. 608-639.

The result of the key switch, FHE.pk₂ (res_{c}), is then transmitted, in step 530, to the HSM_{SP} module.

The HSM_{SP} module decrypts this result using the private key of the second cryptosystem that it contains and provides an unencrypted indicator, res_{c}, to SP in step 540. Alternatively, the HSM_{SP} module may provide this indicator to the SP in an encrypted form, [res_{c}], using conventional encryption (non-homomorphic, asymmetric or symmetrical encryption).

As previously stated, the service provider SP can then return, in step 550, to the compute server CS, an access code (for example a hash value) in addition to the presence/absence indicator.

The querying of the database DB according to the second alternative embodiment is illustrated in FIG. 5B.

A client CL can query the database DB by transmitting, in step 560, to the compute server CS, a query encrypted using the public key of the first homomorphic system, i.e. FHE.pk₁ (req_{c}). In step 570, the compute server CS performs the operation ƒ on the query req, in the homomorphic domain, and obtains the encrypted response FHE.pk₁ (rep_{c})=ƒ(FHE.pk₁ (req_{c})). In step 575, it then performs a key switch for the response thus obtained using the switch key KS₁₂, to obtain FHE.pk₂ (rep_{c}).

In step 580, the response is transmitted to the HSM_{SP} module, which decrypts it using the private key, FHE.pk₂, of the second cryptosystem that it contains. The latter can transmit it in unencrypted or encrypted form ([rep_{c}]) using conventional encryption (asymmetric non-homomorphic or symmetrical encryption) to the service provider SP, in step 590.

Alternatively, according to a third alternative embodiment (not shown), the database can be encrypted using FHE.pk₂, the encrypted confidential information FHE.pk₁ (data) transmitted by the client in FIG. 5A then first being subject to a key switch using KS₁₂, before evaluation by the function ƒ. Similarly, the encrypted query FHE.pk₁ (req_{c}) transmitted by the client in FIG. 5B can first be subject to a key switch using KS₁₂ before evaluation by the function ƒ.

A person skilled in the art will understand that the same database can thus be shared by two separate service providers, the first operating as described with reference to FIGS. 4A and 4B and the second as described with reference to FIGS. 5A and 5B. To achieve this, the HSM_{SP} module of the first service provider needs only to transmit the switch key KS₁₂=FHE.pk₂ (FHE.sk₁) to the compute server CS hosting the database BD encrypted using the key of the first cryptosystem FHE.pk₁. Conversely, if the database is encrypted using the key of the second cryptosystem, the first service provider needs only to transmit the switch key KS₂₁=FHE.pk₁ (FHE.sk₂) to the compute server. In all cases, the presence of the HSM_{SP} module avoids collusion between the compute server and each of the two service providers.

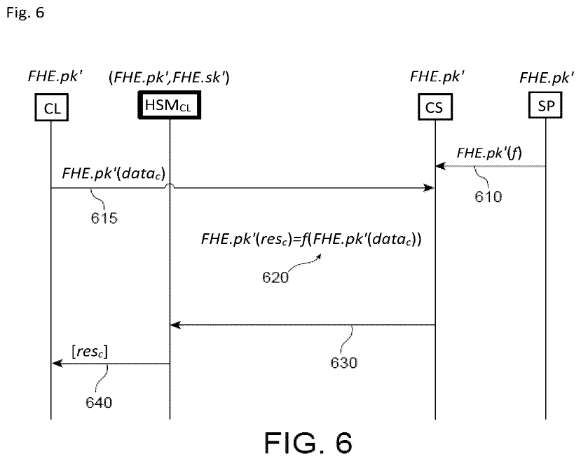

The risk of collusion of the second type between the client and the compute server can be ruled out by adopting a client-server system according to a second embodiment, as shown in FIG. 6.

In this embodiment, the service provider SP delegates, to the compute server CS, the operation ƒ to be performed on the client's confidential data, data_{c}. This operation, for example an inference model in an artificial intelligence application, must also remain confidential with regard to the compute server.

The risk of collusion is avoided here in that the client has an HSM module, hereinafter referred to as HSM_{CL}, containing the homomorphic cryptosystem (FHE.pk′, FHE.sk′) associated with the client. The HSM_{CL} module can be in the form of an electronic board plugged into the client's computer or an external unit. It is suitable for computing homomorphic cryptographic primitives and is advantageously TTP-certified, such as HSM_{SP}.

The parameters of the operation ƒ (for example those of an inference model) are transmitted in encrypted form by the service provider SP to the compute server, in step 610.

When a client CL wishes to have the operation executed on its confidential data, data_{c}, it transmits them, in step 615, in encrypted form FHE.pk′(data_{c}), to the compute server. The latter performs the operation ƒ in the homomorphic domain, in step 620, and returns the result FHE.pk′(res_{c})=ƒ(FHE.pk′(data_{c})) to the HSM_{CL} module in step 630.

The HSM_{CL} module decrypts the result using the private key FHE.sk′ of the homomorphic cryptosystem that it contains and transmits it in unencrypted form, res_{c}, to the client CL. If necessary, the HSM_{CL} module can re-encrypt the result obtained using conventional encryption (asymmetric non-homomorphic or symmetric encryption) before transmitting it, [res], to the client, which then decrypts it using the corresponding private or secret key.

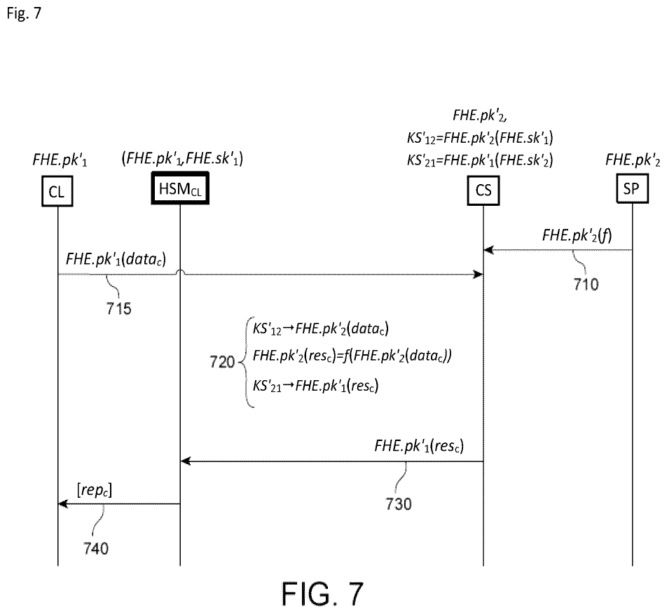

FIG. 7 represents a client-server anti-collusion system of the second type, according to an alternative of the second embodiment of the invention.

In this alternative embodiment, the client's HSM_{CL} module uses a separate cryptographic system from that of the service provider. More specifically, the first cryptosystem associated with the HSM_{CL} module is given the reference (FHE.pk′₁, FHE.sk′₁) and the second cryptosystem associated with the compute server (or, advantageously, of an HSM_{SP} module not shown) is given the reference (FHE.pk′₂, FHE.sk′₂). The compute server or the HSM_{SP} module, if present, also transmits the switch key KS₂₁=FHE.pk′₁ (FHE.sk′₂).

In step 710, the service provider SP transmits, in encrypted form, encrypted using FHE.pk′₂, the parameters of the operation ƒ to be performed, to the compute server.

When a client CL wishes to have the operation executed on its confidential data, data_{c}, it transmits them, in step 715, in encrypted form,

$$FHE \cdot {pk}_{1}^{′} ( {data}_{c} ) ,$$

to the compute server. The HSM_{CL} module also transmits the switch key

$${KS}_{12}^{′} = FHE \cdot {pk}_{2}^{′} ( FHF \cdot {sk}_{1}^{′} )$$

to the compute server.

In step 720, the compute server first performs a key switch for

$$FHE \cdot {pk}_{1}^{′} ( {data}_{c} )$$

using the switch key

$${KS}_{12}^{′} .$$

It then computes the operation ƒ in the homomorphic domain and obtains the result

$$FHE \cdot {pk}_{2}^{′} ( {res}_{c} ) = f ( FHE \cdot {pk}_{2}^{′} ( {data}_{c} ) ) .$$

This result is then subjected to a reverse key switch using the switch key

$${KS}_{21}^{′} ,$$

resulting in the encrypted result

$$FHE \cdot {pk}_{1}^{′} ( re {s}_{c} ) .$$

In step 740, the result thus obtained is transmitted to the HSM_{CL} module which decrypts it using the private key

$$FHE \cdot {sk}_{1}^{′}$$

stored therein, ana provides the result in unencrypted form, res_{c}, to the client in step 750. Alternatively, after decryption, the HSM_{CL} module can re-encrypt the result res_{c} using conventional encryption (asymmetric non-homomorphic or symmetrical encryption) before transmitting it, [res_{c}], to the client, which decrypts it using the corresponding private or secret key.

1. A client-server system comprising a client, a compute server and a service provider, said service provider delegating, to the compute server, an operation to be performed on confidential data from the client, the compute server being suitable for performing said operation on the confidential data, encrypted using the public key of a homomorphic cryptosystem, wherein the service provider, respectively the client, is provided with a hardware security module containing said homomorphic cryptosystem and suitable for decrypting the result of the operation using the private key of said homomorphic cryptosystem to transmit it to the service provider, respectively to the client.

2. The client-server system according to claim 1, wherein the client is suitable for encrypting said confidential data using the public key of the homomorphic cryptosystem and for transmitting them thus encrypted to the compute server.

3. The client-server system according to claim 2, wherein, said client being provided with the hardware security module, the service provider transmits, to the compute server, the parameters of the operation to be performed, encrypted using the public key of the homomorphic cryptosystem.

4. The client-server system according to claim 2, wherein the service provider is provided with the hardware security module and in that the compute server hosts a database encrypted using the public key of the homomorphic cryptosystem, the operation being a primitive indicating whether the confidential data are present in or absent from the database, the service provider returning to the compute server an access code to store the data in the database if the indicator indicates that the data are absent from the database.

5. The client-server system according to claim 4, wherein, to query confidential data in the database, a third-party client transmits to the compute server a query encrypted using the public key of the homomorphic cryptosystem, said query being evaluated in the homomorphic domain, the result of the query then being transmitted to the hardware security module for decryption therein using the secret key of the homomorphic cryptosystem.

6. The client-server system according to claim 1, wherein the service provider is provided with the hardware security module and the compute server hosts a database encrypted using the public key of a second homomorphic cryptosystem that is separate from the homomorphic cryptosystem stored in the hardware security module.

7. The client-server system according to claim 6, wherein the client transmits, to the compute server, the confidential data encrypted using the public key of the second homomorphic system and the compute server performs the operation in the homomorphic domain of the second homomorphic system, with the compute server then performing a key switch for the result of the operation to obtain a result encrypted in the first homomorphic system.

8. The client-server system according to claim 7, wherein, to query confidential data in the database, a third-party client transmits, to the compute server, a query encrypted using the public key of the second homomorphic cryptosystem, said query being evaluated by the server in the homomorphic domain of the second homomorphic system, then being the subject of a key switch to the first homomorphic system, the encrypted result of the query then being transmitted to the hardware security module for decryption therein using the secret key of the first homomorphic cryptosystem.

9. The client-server system according to claim 1, wherein the homomorphic cryptosystem is an FHE cryptosystem.
